(19) United States
(12) Patent Application Publication
(10) Pub. No.: US 2023/0223814 A1
(43) Pub. Date: Jul. 13, 2023

(54) STATOR ARRANGEMENT OF AN ELECTRIC MACHINE AND ELECTRIC MACHINE FOR DRIVING A MOTOR VEHICLE

(71) Applicant: ZF FRIEDRICHSHAFEN AG, Friedrichshafen (DE)

(72) Inventors: Alexander FRANK, Bad Kissingen (DE); Norbert LOHAUS, Schweinfurt (DE); Ralph GUEHRER, Kressbronn (DE)

(21) Appl. No.: 18/009,397

(22) PCT Filed: Jun. 8, 2021
(86) PCT No.: PCT/EP2021/065317

§ 371 Date: Dec. 9, 2022

(30) Foreign Application Priority Data
Jun. 10, 2020 (DE) 10 2020 207 236.1

(51) Int. Cl. H02K 5/20; H02K 9/197

(52) U.S. Cl. CPC H02K 5/203; H02K 9/197

(57) ABSTRACT

A stator arrangement of an electric machine having a substantially cylindrical stator carrier with a radially inner joining surface and with a radially outer joining surface. A lamination stack is arranged at the inner joining surface, and the stator carrier with the outer joining surface is received by an inner joining surface of a housing of the electric machine. A connection between the stator carrier and the housing is carried out with an interference fit, and one of the joining surfaces of the stator carrier and housing, which cooperate with one another, is formed interrupted in circumferential direction.

### CROSS REFERENCE TO RELATED APPLICATIONS

This is a U.S. national stage of Application No. PCT/EP2021/065317 filed Jun. 8, 2021. Priority is claimed on German Application No. DE 10 2020 207 236.1 filed Jun. 10, 2020 the content of which is incorporated herein by reference.

### BACKGROUND OF THE INVENTION

### 1. Field of the Invention

The disclosure is directed to a stator arrangement of an electric machine and to an electric machine for driving a motor vehicle.

### 2. Description of Related Art

During operation of an electric machine, it is necessary to support a reaction torque of the rotating rotor, which reaction torque acts on the stator. To this end, the lamination stack carrying the stator winding is usually secured directly to a housing of the machine by an interference fit or press fit. The invention is directed to an electric machine in which the lamination stack is secured to a separate stator carrier and in which the stator and stator carrier are inserted in a machine housing and secured therein. An arrangement of this kind is shown and described in DE 10 2015 221 777 A1, for example. The connection between the stator carrier comprising multiple parts and the housing is formed as a screw connection, and the threaded bolts are acted upon by tensile forces as well as by transverse forces absorbing the above-mentioned reaction torque. Accordingly, this arrangement necessitates special dimensioning of the threaded bolts. Further, the axially one-sided support of the reaction torque may lead to a twisting of the stator core. In the subject matter of DE 10 2015 221 777 A1, this is to be prevented by axially extending stabilizing rods.

In an electric machine formed as vehicle drive, the requirements respecting the fastening of the stator are particularly demanding because reliable torque support must also be ensured under alternating thermal stress loads within the entire operating temperature range from approximately −40° C. to +140° C. Because of the use of different materials with different thermal expansion behaviors and the resulting lengths and diameter changes in the elements of the stator arrangement, it may prove difficult in terms of construction to achieve an optimal layout of the joining areas. Further, as is also generally stated in DE 10 2015 221 777 A1, a fluid cooling jacket and seal arrangements formed in addition to the joining connection can be provided between the stator carrier and the housing. In this case, changes in temperature—also due to trapped air volumes—can lead to changes in pressure, component stresses induced thereby, and possibly also leaks. The prior known solution can be disadvantageous in further respects, also with respect to a noise, vibration and harshness behavior (abbreviated NVH), i.e., the phenomenon of unwanted occurrence of reciprocal component/aggregate vibrations and associated bothersome noises.

### SUMMARY OF THE INVENTION

One aspect of the invention is to improve a stator arrangement of an electric machine of the type mentioned in the introduction and to overcome the disadvantages described above.

Advantageous configurations and further developments of aspects the invention will be apparent from the following description and the figures.

Accordingly, a stator arrangement of an electric machine is proposed that comprises a substantially cylindrical stator carrier with a radially inner joining surface and with a radially outer joining surface, a lamination stack being arranged at the inner joining surface, and the stator carrier with the outer joining surface being received by an inner joining surface of a housing of the electric machine.

First, it is suggested according to one aspect of the invention that the connection between the stator carrier and the housing be carried out by an interference fit. However, it has turned out in this regard that undesirably high mechanical stresses can occur locally when providing a conventional, that is, a circumferentially closed, interference fit due to inevitable manufacturing tolerances and assembly tolerances of the parts. This is also the case in particular when at least one of the joining partners is not formed rotationally symmetrical around the common center axis and joining axis. In case of an unfavorable tolerance stack-up, mismatches may be produced with respect to the mutual orientation of adjoining component parts, which either requires re-machining of the joint or renders the already produced assemblies unusable.

The inventors had the insight that a symmetrical distribution of mechanical stresses does not occur in a conventional interference fit of stator carrier and housing with respect to the center axis in circumferential direction. On the contrary, mechanical stress peaks occur due to design-dependent deviations in symmetry of the joined component parts in different radial directions.

It is further provided according to one aspect of the invention that one of the joining surfaces of the stator carrier and housing, which cooperate with one another is formed interrupted in circumferential direction.

Because of the interference fit of the connection partners which is interrupted in circumferential direction as a result, an excessive tension and a deformation of the joining partners possibly resulting from this can be prevented at critical positions. Such a position may be a fastening area of the stator carrier in the form of a segmented annular collar or of individual screw lugs for screwing to the machine housing.

As a result, the rest of the associated disadvantageous effects such as mismatches or misorientations with respect to neighboring component parts or leakage problems are also minimized or entirely eliminated. After-machining of the unit comprising the joining partners or of an element cooperating with the latter may be dispensed with. At the same time, as a result of interrupting the joining surface, a pressure equalization channel can be provided for an air volume located between a joining surface and a seal arrangement. Accordingly, no additional mechanical stresses occur during changes in temperature due to changes in volume.

Screw bolts or other axial fasteners used for axially securing the stator between the stator carrier and the machine housing do not experience transverse forces at least substantially and can accordingly be optimized chiefly with respect to their tensile loading. The interference fit provided between the stator carrier and the housing successfully supports reaction torque which may occur, that is, at least substantially without the assistance of the axial connection elements. In this way, the reaction torque can be distributed axially along the extension of the stator and the lamination stack can be prevented from twisting.

As a result of the suggested interference fit, the stator carrier with the lamination stack secured thereto is more firmly coupled to the machine housing so that a mutual vibration of these parts is at least sharply curtailed and suppressed and the NVH behavior is accordingly also noticeably improved.

On the whole, the above-mentioned solution to the stated problem allows an operationally reliable securing and torque support of the stator without the disadvantageous effects mentioned in the introduction. The solution further allows wider tolerances for joining the connection partners.

According to an advantageous aspect, the stator carrier can have two outer joining surfaces which are spaced apart from one another axially and which are formed with a larger outer diameter compared to a circumferential area of the stator carrier located axially between these two joining surfaces, at least one of these joining surfaces of the stator carrier being interrupted in circumferential direction. Accordingly, both joining surfaces can also be formed interrupted. An axial split or forming axially divided joining surfaces contributes to a further reduction of stresses. The two axially spaced joining surfaces can be provided, respectively, at different axial end areas of the stator carrier and can therefore be substantially as far apart from one another as possible.

Further advantageously, a fluid cooling jacket can be formed in the stator arrangement axially at the circumferential region between the joining surfaces of the stator carrier and housing. Further, seal arrangements are formed between the stator carrier and the housing for producing a fluid-tight connection of the parts, these seal arrangements being closed in circumferential direction and located adjacent to one of the joining surfaces of the stator carrier in each instance. Because at least one or both of the joining surfaces are formed interrupted, sealing elements utilized at the seal arrangement, for example, O-rings, are loaded and deformed approximately uniformly in circumferential direction.

Insofar as a plurality of stress-critical positions or directions occur in the opposing joining area in circumferential direction, it may be advantageous to form one of the mutually cooperating joining surfaces of the stator carrier and housing to be repeatedly interrupted in circumferential direction corresponding to these positions or directions, as a result of which at least two joining surface segments occur. Such joining surface segments can be realized, for example, as local diameter changes in the casting blank of the stator carrier.

For the purpose of a spatial homogenization of mechanical stresses that occur, it may be useful that the joining surface segments of two joining surfaces of the stator carrier which are axially spaced apart are arranged offset to one another in circumferential direction and/or that they are formed with a different circumferential extension.

In a stator arrangement, particularly for a vehicle drive, the housing can advantageously comprise a ferrous casting material and the stator carrier can be produced from an aluminum casting material.

The connection of the inner joining surface of the stator carrier to the lamination stack can also be carried out with an interference fit in the stator arrangement proposed herein. Accordingly, the stator carrier is connected to the radially adjoining elements by both its radially inner joining surface and its radially outer joining surface by an interference fit.

According to a further aspect of the invention, an electric machine for driving a motor vehicle comprises a stator arrangement as described above and a rotor which is rotatably supported relative to the latter.

### BRIEF DESCRIPTION OF THE DRAWINGS

The invention will be described in the following referring to an exemplary embodiment form shown in the drawings.

The drawings show:

FIG. 1 is a schematic view of an electric machine with a rotor and a stator arrangement;

FIG. 2 is a perspective view of a stator carrier of the stator arrangement from FIG. 1; and

FIG. 3 is a side view of the stator carrier from FIG. 2.

### DETAILED DESCRIPTION OF THE PRESENTLY PREFERRED EMBODIMENTS

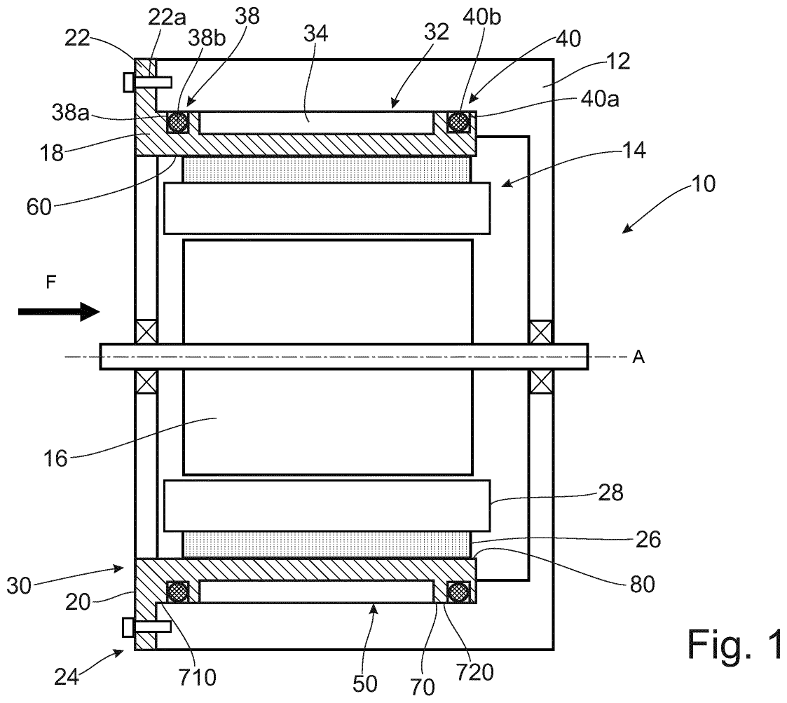

FIG. 1 shows an electric machine 10 for driving a motor vehicle. The electric machine 10 has a stator 14 secured to a machine housing 12 and a rotor 16 arranged radially inwardly thereof and supported so as to be rotatable around an axis A. The electric machine 10 can be formed as a drive unit in a hybrid vehicle for cooperating with an internal combustion engine or, alternatively, used by itself or with further electric machines as drive unit in an electric vehicle. The further construction and principle of operation of the electric machine 10 are not pertinent to the following. The electric machine 10 can operate, for example, as a permanently excited synchronous machine or as an asynchronous machine.

The stator 14 comprises a substantially cylindrical stator carrier 18 made from an aluminum casting material, two collar-shaped, radially outwardly directed fastening areas 22 being formed thereon at a front end portion 20. The fastening areas 22, which are formed as fastening lugs in the present instance, have through-openings 22a for producing a screw connection 24 to the housing 12. As will be apparent from FIG. 1, a radially inner joining surface 60 is provided at the stator carrier 18, a lamination stack 26 with a stator winding 28 being arranged at the radially inner joining surface 60 in a known manner by an interference fit. Further, a radially outer joining surface 70 is formed at the stator carrier 18. The radially outer joining surface 70 is received by an inner joining surface 50 of the housing 12 of the electric machine 10 and an interference fit is likewise formed with it. Together with the housing 12, which can be produced from a ferrous casting material in the embodiment example described herein, the stator 14 forms a stator arrangement 30.

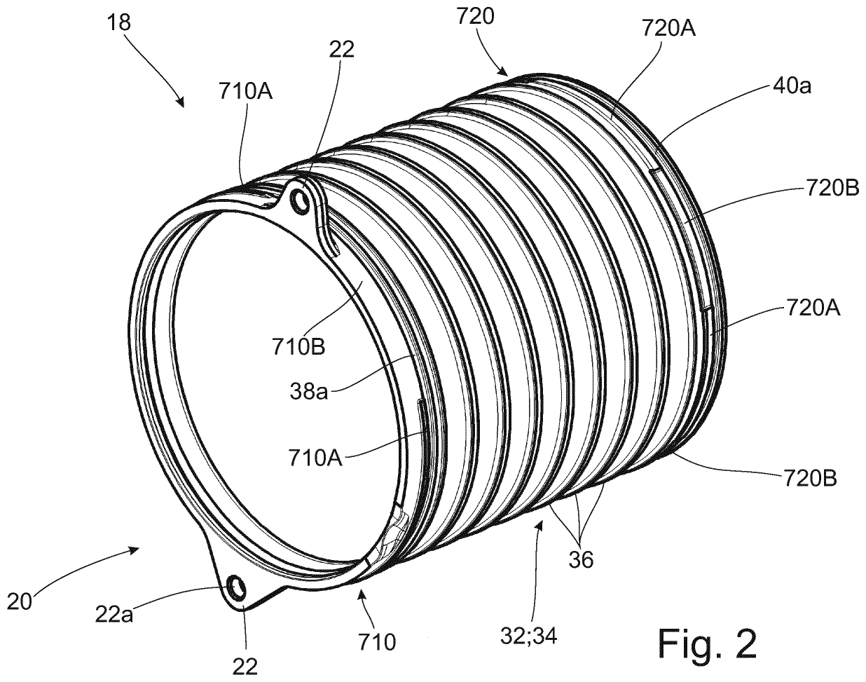

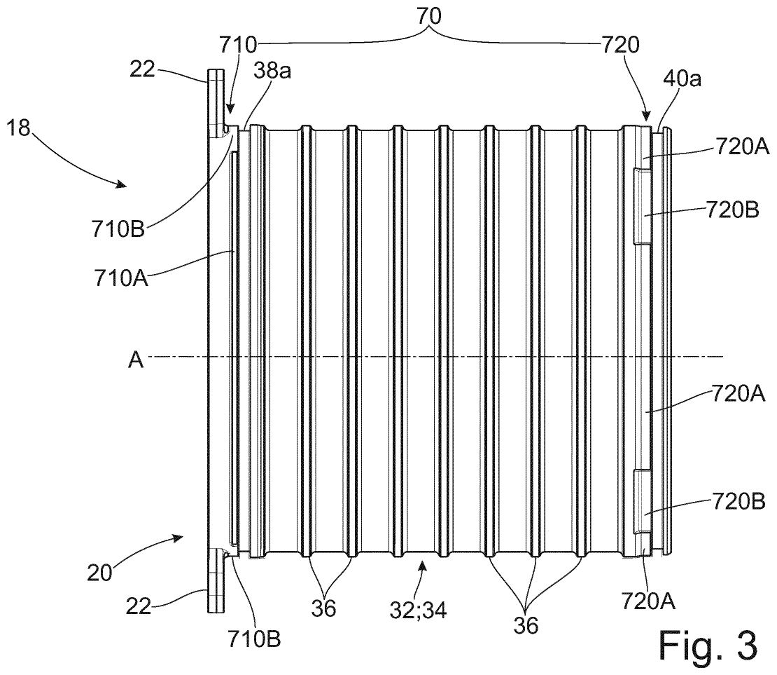

Still referring to FIG. 1, a fluid cooling jacket 32 with a cooling channel 34 is provided radially between the stator carrier 18 and the housing 12 for cooling the electric machine 10, as a result of which heat losses can be carried off from the lamination stack 26 in particular. To form the cooling channel 34, the outer joining surface 70 of the stator carrier 18 is interrupted and is accordingly formed of two parts with joining surfaces 710 and 720. In other words, joining surfaces 710, 720 axially enclose the cooling channel 34 and, at least in some portions, have a larger outer diameter compared to it. Webs or fluid guide ribs 36 extending in circumferential direction are provided inside of the cooling channel 34 for the purpose of optimizing the flow of a coolant flowing therein. Seal arrangements 38, 40, which are closed in circumferential direction are formed axially at both sides of the cooling channel 34 for the fluid-tight connection of the stator carrier 18 and housing 12. The seal arrangements 38, 40 are positioned upstream of the aforementioned joining surfaces 710, 720 in each instance in an axial joining direction F of the stator 14 to the housing 12 and respectively comprise an annular groove 38a, 40a at the stator carrier 18 and an annular seal 38b, 40b which is inserted therein and which cooperates with the inner joining surface 50 of the housing 12. It should be noted that the configuration of the joining surfaces 710, 720 and seal arrangements 38, 40 is only shown schematically in FIG. 1. FIG. 2, and FIG. 3 show a more exact configuration of these features.

The stator carrier 18 is configured to be substantially not rotationally symmetrical by the fastening areas 22, which are formed opposite one another at the center axis A. Accordingly and also owing to the manufacturing tolerances and assembly tolerances, high mechanical stresses can occur locally in an unwanted manner particularly in the mutual connection area of the stator carrier 18 and housing 12. By way of a remedy, it is provided to form at least one of the mutually cooperating joining surfaces 710, 720; 50 of the stator carrier 18 and housing 12 to be interrupted in circumferential direction. An excessive stressing and deformation possibly resulting therefrom at critical positions are prevented by the resulting interference fit of connection partners which is interrupted in circumferential direction.

As will be seen from FIG. 2, the two joining surfaces 710, 720 which are axially spaced apart from one another are interrupted multiple times in circumferential direction and formed, respectively, with a plurality of joining surface segments 710A; 720A and recesses 710B; 720B located therebetween. The recesses 710B, 720B are realized in this instance by local diameter changes in the casting blank of the stator carrier 18. For the purpose of a spatial homogenization of occurring mechanical stresses, the joining surface segments 710A, 720B of the two joining surfaces 710, 720 are arranged offset to one another in circumferential direction and also formed with a different circumferential extension.

The interference fit existing between the inner joining surface 60 of the stator carrier 18 and the lamination stack 26 is comparatively noncritical with respect to mechanical stresses due to the spaced spatial position relative to the two fastening areas 22. Therefore, the inner joining surface 60 is formed circumferentially closed, and an outer joining surface 80 of the lamination stack 26 cooperating with the inner joining surface 60 can optionally have corresponding cutouts for absorbing mechanical stresses which may possibly occur. Accordingly, the stator carrier 18 is connected by its radially inner joining surface 60 and its radially outer joining surface 70 by an interference fit to the radially adjoining elements 12, 26 so as to be fixed with respect to rotation relative to it.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A stator arrangement of an electric machine comprising:
a stator carrier that is substantially cylindrical having a radially inner joining surface and a radially outer joining surface;
a lamination stack is arranged at the radially inner joining surface; and
a housing having an inner joining surface configured to receive the stator carrier with the radially outer joining surface;
wherein a connection between the stator carrier and the housing is carried out by an interference fit between the inner joining surface and the radially outer joining surface, and
wherein one of the inner joining surface and the radially outer joining surface is formed interrupted in circumferential direction.

10. The stator arrangement according to claim 9, wherein the stator carrier has two outer joining surfaces which are spaced apart from one another axially and which are formed with a larger outer diameter compared to a circumferential area of the stator carrier located axially between these two joining surfaces, and wherein at least one of these two joining surfaces of the stator carrier is interrupted in circumferential direction.

11. The stator arrangement according to claim 10, further comprising:
a fluid cooling jacket formed by a circumferential region axially between the inner joining surface and the radially outer joining surface of the stator carrier and housing; and
seal arrangements which are closed in circumferential direction are formed between the stator carrier and the housing, the seal arrangements arranged adjacent to one of the two joining surfaces of the stator carrier in each instance.

12. The stator arrangement according to claim 11, wherein one of the mutually cooperating joining surfaces of the stator carrier and housing is interrupted multiple times in circumferential direction and forms at least two joining surface segments.

13. The stator arrangement according to claim 12, wherein the at least two joining surface segments of two joining surfaces of the stator carrier which are axially spaced apart from one another are arranged offset to one another in circumferential direction and/or have a different circumferential extension.

14. The stator arrangement according to claim 9, wherein the housing is a ferrous casting material and the stator carrier is an aluminum casting material.

15. The stator arrangement according to claim 9, wherein the connection of the inner joining surface of the stator carrier to the lamination stack is an interference fit.

16. An electric machine for driving a motor vehicle, comprising:
a stator arrangement comprising:
a stator carrier that is substantially cylindrical having a radially inner joining surface and a radially outer joining surface;
a lamination stack is arranged at the radially inner joining surface; and
a housing having an inner joining surface configured to receive the stator carrier with the radially outer joining surface;
wherein a connection between the stator carrier and the housing is carried out by an interference fit between the inner joining surface and the radially outer joining surface, and
wherein one of the inner joining surface and the radially outer joining surface is formed interrupted in circumferential direction; and
a rotor which is rotatably supported relative to the stator.
